(19) United States
(12) Patent Application Publication
(10) Pub. No.: US 2006/0016460 A1
(43) Pub. Date: Jan. 26, 2006

(54) Method and apparatus for cleaning plastic film wherein the plastic film remains substantially intact

(76) Inventor: Curtis W. Cozart JR., Montclair, NJ (US)

Correspondence Address: ETHERTON LAW GROUP, LLC, 5555 E. VAN BUREN STREET, SUITE 100, PHOENIX, AZ, 85008, US

(21) Appl. No.: 11/185,218

(22) Filed: Jul. 19, 2005

Related U.S. Application Data
(60) Provisional application No. 60/589,603, filed on Jul. 20, 2004.

(51) Int. Cl. B08B 11/00

(52) U.S. Cl. 134/6; 134/21; 134/64 R; 134/122 R; 15/321; 15/302

(57) ABSTRACT

A method and apparatus for recycling plastic by removing contaminates from plastic film and leaving the film substantially intact. The preferred embodiment is particularly applicable to agfilms. The method comprises pulling used plastic film from the form it is stored into when removed from the field, spreading it open, and removing contaminates from the film. Contaminates are removed with dry or wet processes, or a combination of both. The wet processes may use water, surfactant, detergent, flocculant, solvent, disinfectant or deodorant, and the film is dried after wet processing. If necessary, sections of film containing contaminates that cannot be removed in the downstream equipment, such as glue, may be cut from the film. The discharge of the process is one or more relatively clean and dry film strips that are then wound, ground or melted for reuse.

### CROSS-REFERENCE TO RELATED APPLICATIONS

This application claims the benefit of co-pending U.S. Provisional Application No. 60/589,603 filed Jul. 20, 2004.

### FIELD OF INVENTION

The present invention relates to recycling plastics. More particularly, the present invention relates to cleaning sheets of agricultural film while leaving the sheet substantially intact, so that the cleaned plastic can be recycled less expensively.

### BACKGROUND

Plastic film is used in agricultural applications such as fruit and vegetable farms, tobacco farms, nurseries, greenhouses, dairy farms and cattle ranches for a number of reasons. Film is used as silage bags, bunker silo covers, bale wraps, greenhouse covers, or irrigation tubing while other films are placed on or over the crops in situ as row covers or mulch films. For example, transparent mulch film is used to encourage early season plant growth and early cropping; black mulch films are used to control weed growth; and white films provide reflected sunlight for the plants. In all cases, a more productive crop growth with the available water, chemical, space and growing season resources is achieved. These films are referred to in the industry as “agfilm.”

Most agfilms are 5 to 200 microns in thickness and are used in widths up to 3 meters. Multiple rolls of plastic are often glued together, both end-to-end and side-to-side, to create huge sheets of plastic to cover entire fields. The plastic is typically low density polyethylene (LDPE), high density polyethylene (HDPE), linear low density polyethylene (LLDPE) or a combination thereof, but may also composed in part or entirely of other polymers such as polyethylene terephthalate (PET), polyvinylacetate, polypropylene, polyvinylalcohol and polyvinylchloride (PVC). After use, the plastic is collected and removed from the point of use by rolling it into rolls, baling it, or gathering it into piles. The film is then disposed of or, preferably, recycled.

Because this film may come in contact with crops, soil, stones, silage, vegetation, agricultural chemicals such as fertilizers, pesticides, herbicides and ripeners, and other agricultural products, the collected material entraps many types of contaminates that must be removed prior to the plastic's reuse. The accepted process for performing the removal of contaminates from the used plastic is to cut it into smaller, free flowing pieces, referred to in the art as fluff, and removing contaminates through sorting by size, density, resistance to breakdown by mechanical agitation, magnetism, flowability in air, and washing. For example, U.S. Pat. Nos. 5,510,076 and 5,635,224 issued to Brooks, U.S. Pat. No. 5,695,133 issued to Morse et al., and U.S. Pat. No. 5,853,013 issued to Busick et al. all describe recycling apparatuses that shred, wash and dry the plastic. The clean plastic pieces, now a raw material, are then melted and extruded into a reusable form, such as pellets.

One of the disadvantages of turning the plastic film into fluff before cleaning it is that the small plastic pieces cannot easily or efficiently be cleaned with a mechanical process that actually touches the plastic, yet brushing and wiping are two of the most effective methods of cleaning contaminates from the film. There is no tension on the pieces to hold them in place while mechanically processing them and it would be impractical to brush or wipe-off each loose plastic piece. It is desirable to be able to physically contact substantially all of the plastic surface with a mechanical cleaning method.

Another disadvantage of presently known methods is that cutting the plastic into free flowing pieces prior to removing contaminates wears the cutting machine. Blades used to shred, grind or chop the contaminated plastic not only have to cut the plastic, they also have to chop through contaminates, including sand and pebbles. While the plastic is relatively easy to cut, contaminates are much harder and are not as easy to cut. Even hardened blades dull quickly and need to be replaced frequently—a large portion of the recycling processing cost. Further, more electricity is needed to provide more power to chop through the harder materials. It is desirable to reduce the cost of recycling plastic. Reducing blade usage and energy consumption would significantly reduce the cost of recycling plastic.

Drying fluff is also much more expensive than drying sheets because fluff cannot be dried with a mechanical process that actually touches the plastic, yet squeegeeing and wiping are two of the most cost effective methods of drying water from the film. There is no tension on the pieces to hold them in place while mechanically processing them and it would be impractical to squeegee or wipe-off each loose plastic piece. It is desirable to be able to physically contact substantially all of the plastic surface with a mechanical drying method.

The logistical issues associated with washing, transporting and drying fluff are costly as well. The bulk density of fluff is much lower than rolls or bales of plastic, and thus requires much larger machines and transport systems, which are capitally and operationally expensive, than sheet. It would be desirable to remove contaminates and process the film as a sheet to avoid these costs.

Therefore, an object of this invention is to provide a method and apparatus for cleaning plastic that eliminates contaminates prior to shredding or grinding it for recycle. Another object of this invention is to provide a method and apparatus that physically contacts the film to clean and dry it.

### SUMMARY OF THE INVENTION

The present invention is a method and apparatus for recycling plastic by removing contaminates from plastic film and leaving the film substantially intact. The preferred embodiment is particularly applicable to agfilms. The method comprises pulling used plastic film from the form it is stored into when removed from the field, spreading it open, and removing contaminates from the film. Contaminates are removed with dry or wet processes, or a combination of both. The wet processes may use water, surfactant, detergent, flocculent, solvent, disinfectant or deodorant, and the film is dried after wet processing. If necessary, sections of film containing contaminates that cannot be removed in the downstream equipment, such as glue, may be cut from the film. The discharge of the process is one or more relatively clean and dry film strips that are then wound, ground or melted for reuse.

### BRIEF DESCRIPTION OF THE DRAWINGS

FIG. 1 is a flow diagram illustrating a first embodiment of the present method.

FIG. 2 is a flow diagram illustrating a second embodiment of the present method.

FIG. 3 is a schematic illustration of the preferred apparatus used to implement the first embodiment of the present method.

### DETAILED DESCRIPTION OF THE INVENTION

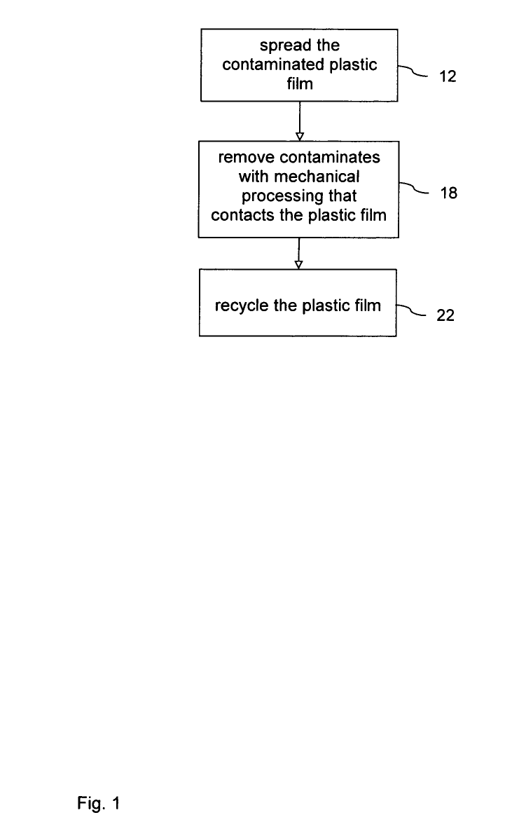

The present method applies particularly to agfilms in both sheet and tube form, but may be used with any flexible plastic. The contaminated film is preferably received in rolls, but alternatively may be gathered, bunched, or baled. FIG. 1 illustrates a first embodiment of the present method. The contaminated film is fed into a positive-feed apparatus, in which the film is pulled from one end of the apparatus to the other. This is also referred to as web processing, in which the film is the web material; it differs from conventional processing in which the film is carried on a conveyor belt. If the film is in the form of a tube, it is first split open so the tube is somewhat flat. The film is spread open 12 to remove wrinkles and make contaminate removal easier. Contaminates are removed by a mechanical process 18 that contacts the film. Such processes include rubbing, brushing, wiping, or scraping. The cleaned film can then be shredded, ground or melted as part of a conventional plastic recycling process.

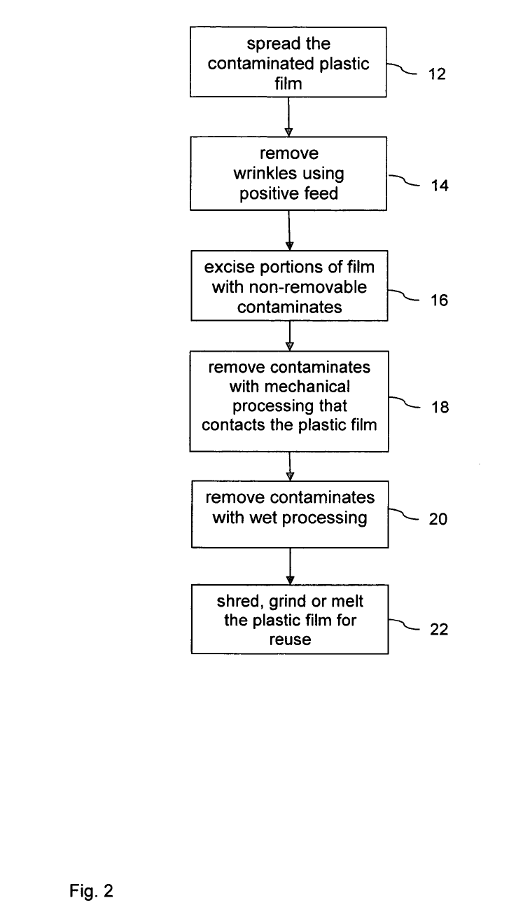

FIG. 2 illustrates a second embodiment of the present method. Again, the contaminated film is fed into a positive feed apparatus, in which the film is pulled from one end of the apparatus to the other. If the film is in the form of a tube, it is first split open so the tube is now somewhat flat. The film is spread open 12 and wrinkles and folds are removed 14 so that contaminates are not entrapped and can more easily be removed. Sections of film containing contaminates that cannot be removed by dry or wet processing, such as glue, may be cut from the film 16. Removing intractable contaminates can be done prior to, or after the cleaning.

Contaminates are then removed by dry or wet processing, or a combination of both. Preferably, the processing includes at least one mechanical process 18 that contacts the film. Such processes include rubbing, brushing, wiping, or scraping. Preferably dry processing is conducted first but, if multiple cleaning steps are required, the wet and dry processes may be taken in any order or in alternating order.

Dry processing 16 removes contaminates with contact processes such as rubbing, brushing, wiping and scraping, as well as non-contact processes such as vibrating, blowing, electrostatically removing, or manually removing contaminates. Brushes are similar to those used in street sweepers, with stiff bristles. The stiff bristles have the advantage of being essentially self-cleaning, as the debris that is disengaged from the plastic simply falls off the bristles. Preferably both sides of the film are cleaned simultaneously, however each side of the film may be cleaned separately and at different times. The film may be cleaned as a single sheet or, if a contaminated strip has been removed, the sheets can be separated and cleaned separately, in parallel or in series.

Then the film is cleaned with a wet process 20. Wet processing 18 removes contaminates by wetting the film. The wet process may include physical contact processes, such as brushing, squeegeeing or scrubbing, or non-contact processes such as spraying or washing the film through a bath of fluid. The brushes used for wet processing are similar to paint rollers, that is, fabric-covered rollers that entrap contaminates. In a preferred embodiment, a wet brush is used to remove contaminates, while a vacuum simultaneously sucks the water and contaminates from the fabric. The fluid may be water or other solvent, and may include surfactants, detergents, flocculants, solvents, disinfectants or deodorants. The film is dried after wet processing usually by squeegee, wiping, or blowing hot air, and the drying may be a function of one or more of the dry processes, above.

The discharge of is one or more film strips that have remained substantially intact from the input feed. The contaminated strips, if any, are typically wound into rolls for easier handling and disposal. The cleaned film can then be shredded, ground or melted as part of a conventional plastic recycling process 22.

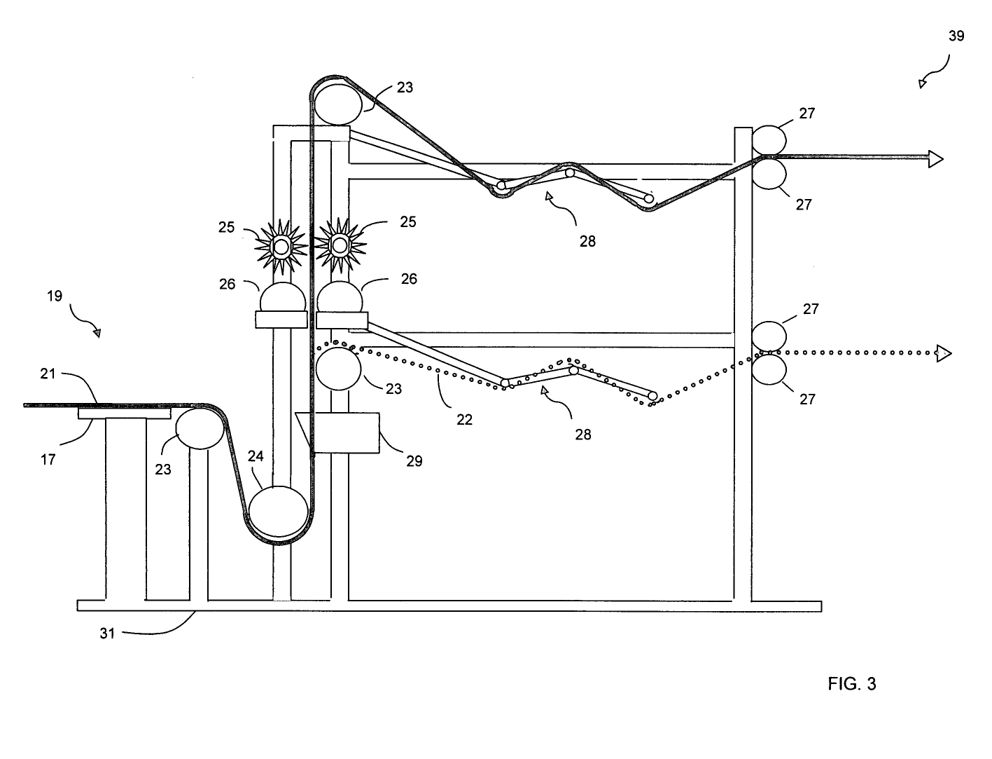

FIG. 3 illustrates one embodiment of the apparatus, a variable speed continuous web processor. The rolls, bales or bunches of film are placed at the infeed end 19 of the machine in a manner that the film can be fed in the direction of the downstream machinery. The film is pulled through the apparatus by one or more nip rollers 27 at the discharge end 39 of the feed. The nip rollers 27 and the spreader roller 24, discussed below, are active rollers, using an electric, pneumatic, hydraulic or other external drive mechanism. To help keep the proper tension on the web, one or more passive tensioning rollers, such as idler rollers 23 and dancer assemblies 28 are spaced between the infeed 19 and discharge end 39. Passive rollers move in response to the web and are not externally driven. To effect the cleaning, passive and active cleaning mechanisms are spaced between the infeed 19 and discharge end 39. Preferably the various components are supported on a frame 31 so that the apparatus is a single unit. However, stand-alone components may be used.

The film 21 is loaded at the infeed end 19. If the contaminated film arrives in rolls and an unwinder is required, it is placed at the infeed end 19 and can be driven by a shaft which penetrates the core of the roll, clamps onto the sides of the roll, or a combination of belts which drive the surface of the roll like a wheel. The unwinder (not shown) is driven in a speed according to the availability of the downstream equipment. If the film 21 is a tube, the tube is split open with a splitter (not shown) so that it forms a flat sheet-like film.

Preferably the infeed end 19 comprises a surface 17 where the ends of the film can be attached to each other for continuous processing, for example by plastic welds. The film 21 is drawn over a spreader roller 24 which spreads the film and pulls wrinkles out. The spreader roller 24 is preferably grooved in a chevron pattern to pull wrinkles to the outside. The spreader roller 24 is preferably electrically driven and cooperates with the nip rollers 27 to keep uniform tension on the web. Alternatively, the wrinkles may be removed by one or more other types of angled rollers, bowed rollers, or by hand. Concurrently the film is pulled downstream by the nip rollers 27 so that a flat, open sheet of film progresses into the downstream machines.

Sections of film containing contaminates that cannot be removed by dry or wet processing may be cut from the film with blades positioned either by hand or automatically through commercially available machines designed to detect a characteristic of that contaminate. Often film 21 has a glue strip 22 along its entire length where sheets of plastic were glued together side-by-side to create wider film. This glue strip 22 is not removable by wet or dry processing and must be cut out of the film. In such case, the apparatus will include a slitter 29 that comprises one or more pairs of blades to excise the strip of glue as the film is pulled downstream. If the film does not have such a glue strip, the slitter is not needed. The glue strip is separated from the film and pulled downstream by nip rollers 27

The film then passes through one or more mechanical processes that physically contacts the film 21 to remove contaminates. In the preferred embodiment, the film 21 passes vertically upwards through a pair of rotating brushes 25 and gravity causes contaminates to fall downward. Contaminates are caught by a pair of augers 26 that carry contaminates away transversely to the flow of the film. Other mechanical processes that can be used to clean the film with physical contact include rubbing, wiping or scraping. In addition, non-contact dry processes can be used, such as vibrating, blowing, electrostatically removing, or manually removing contaminates. Liberated contaminates are collected either mechanically or through an air filter system.

After dry contaminate removal, if necessary, the film may be wet processed to further wash contaminates from it. Washing solutions may contain water, surfactants, detergents, flocculants, or solvents, alone or in combination. Chlorine or other chemical may be used to disinfect or remove odors. Wet processing may be used alone or in combination with dry processing. If used alone, the wet process uses mechanical process that physically contacts the film 21 to remove contaminates. Examples of mechanical wet processing include scrubbing by wetted rotating cylindrical brushes or rolls. Examples of non-contact wet processing include passing the film through tanks filled with washing solution or passing the film under nozzles spraying rinsing agents. The film is dried after wet processing usually by squeegeeing, wiping, or blowing air across the film, and the drying may be a function of one or more of the dry processes, above.

An important objective of web processing is to maintain tension within the desired limits under a wide range of dynamic conditions such as speed changes, variations in roll sizes, and web property. Tension variations affect cleaning quality and tend to cause web breakage and wrinkles. Disturbances arising from unevenly wound rolls and misalignment of the rolls have to be attenuated by the dancer mechanism, thus negating their propagation into the in-feed section. Imperfections of thickness, flatness, elasticity and other properties of the film, as well as imperfections of web-handling machinery, may cause the web to run off center of the process line, often resulting in damage to the web as well as waste. Therefore, in the preferred embodiment, the film then passes through one or more dancer assemblies 28, which serves to maintain the proper tension of the web. Web guides may be required for maintaining lateral alignment of the web.

The discharge of the apparatus is one or a number of film strips. These strips, as well as waste contaminated film sections, such as the glue strips, are mechanically collected, baled or rolled for easier handling. The cleaned film is then turned into fluff for recycling, typically by shredding or grinding it. The shredder or grinder may be attached in series to the cleaning device described herein. The fluff is then melted for reuse.

Depending on the number and types of processes necessary to clean the plastic for reuse, the apparatus may be implemented at or near the site of the plastic use. For example, an apparatus may be installed at a grower's fields with only power and water necessary for installation. That, in combination with the fact that the present method and apparatus do not wear cutting machinery blades, greatly simplifies the recycling process. Alternatively, the apparatus can be implemented at a recycling facility where the cleaned plastic is either redistributed for re-use, or further processed through conventional methods of film processing.

While there has been illustrated and described what is at present considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

I claim:

1. A method for cleaning film that is to be recycled, the method comprising:
a) removing contaminates from film while it remains substantially intact.

2. A method for recycling film comprising:
a) spreading the film; and
b) removing contaminates from the film while it remains substantially intact.

3. The method of claim 2 wherein spreading the film is accomplished using a positive-feed mechanism.

4. The method of claim 2 wherein removing contaminates further comprises at least one mechanical process that contacts the film.

5. The method of claim 4 wherein the mechanical process further comprises one or more of:
a) rubbing, brushing, wiping, or scraping.

6. The method of claim 2 wherein removing contaminates further comprises one or more of:
a) vibrating, blowing, electrostatically removing, or manually removing.

7. The method of claim 2 further comprising:
a) removing contaminates by at least one wet process.

8. The method of claim 7 wherein the wet process further comprises at least one of:
a) washing, squeegeeing, spraying, brushing or scrubbing.

9. The method of claim 8 wherein the wet process uses at least one of:
a) water, surfactant, detergent, flocculant, solvent, disinfectant or deodorant.

10. The method of claim 7 further comprising.
a) drying the film after wet-processing it.

11. The method of claim 2 further comprising:
a) excising sections of film that cannot be cleaned by dry or wet processing.

12. The method of claim 2 wherein the film is a tube and the method further comprises splitting the tube open to form a sheet of film.

13. The method of claim 2 further comprising turning the cleaned film into fluff.

14. An apparatus for cleaning film that is to be recycled comprising:
a) a positive feed mechanism; and
b) a mechanical cleaning device that contacts the film while the film remains substantially intact as it is drawn through the positive feed mechanism.

15. The apparatus of claim 14 further comprising a spreader to remove wrinkles from the film.

16. The apparatus of claim 14 further comprising a slitter to excise sections of film that cannot be cleaned by cannot be removed by dry or wet processing.

17. The apparatus of claim 14 wherein the film is a tube and the apparatus further comprises a splitter to split the tube open to form a sheet of film.

18. The apparatus of claim 14 further comprising:
a) one or more idler rollers; and
b) one or more dancer assemblies.

19. The apparatus of claim 14 wherein the mechanical cleaning device is a brush.

20. The apparatus of claim 14 further comprising a wet cleaning process.

21. The apparatus of claim 20 wherein the wet cleaning process further comprises:
a) a wet brush; and
b) a vacuum.

22. The apparatus of claim 14 further comprising a shredder or grinder.

23. An apparatus for cleaning film that is to be recycled, the apparatus comprising:
a) an input end and a discharge end;
b) one or more nip rollers to pull the film from the input end to the discharge end;
c) a spreader comprising a roller with grooves in a chevron pattern;
d) a slitter to remove contaminates that cannot be removed by the brush;
e) a brush;
f) an auger positioned such that contaminates removed by the brush fall onto it; and
g) one or more idler rollers and one or more dancer assemblies to help maintain proper tension on the film as it passes from the input end to the discharge end.

24. The apparatus of claim 23 wherein:
a) contaminates that cannot be removed by the brush include a glue strip along the length of the film, wherein the glue strip is excised by the slitter; and
b) one or more idler rollers and one or more dancer assemblies to help maintain proper tension on the excised glue strip as it passes from the input end to the discharge end.

25. The apparatus of claim 23 further comprising a splitter.

26. The apparatus of claim 23 further comprising a shredder or grinder.
